(19) United States
(12) Patent Application Publication
(10) Pub. No.: US 2025/0091870 A1
(43) Pub. Date: Mar. 20, 2025

(54) Regular Octahedral Iron Phosphate, Preparation Method Thereof, Lithium Iron Phosphate Cathode Material, and Lithium Iron Phosphate Battery

(71) Applicants: QUZHOU HUAYOU COBALT NEW MATERIAL CO., LTD., Quzhou (CN); ZHEJIANG HUAYOU COBALT CO., LTD., Jiaxing (CN); ZHEJIANG YOUSHAN NEW MATERIAL TECHNOLOGY CO., LTD., Jiaxing (CN)

(72) Inventors: Qiutao Tong, Jiaxing (CN); Min Liu, Jiaxing (CN); Yue Ma, Jiaxing (CN); Yuting Hou, Jiaxing (CN)

(21) Appl. No.: 18/726,582

(22) PCT Filed: Aug. 8, 2023
(86) PCT No.: PCT/CN2023/111816

§ 371 Date: Jul. 3, 2024

(30) Foreign Application Priority Data
Sep. 2, 2022 (CN) 202211070666.5

(51) Int. Cl. C01B 25/37; H01M 4/58

(52) U.S. Cl. CPC C01B 25/375; H01M 4/5825; C01P 2002/76; C01P 2004/03; C01P 2006/11; C01P 2006/40

(57) ABSTRACT

A regular octahedral iron phosphate, a preparation method thereof, a lithium iron phosphate cathode material, and a lithium iron phosphate battery are disclosed. The method for preparing the regular octahedral iron phosphate includes: obtaining a mixed solution A containing a phosphate and a ferrous salt, in which, the mixed solution A is an acidic solution; mixing the mixed solution A with an oxidant, during which, ferrous ions in the mixed solution A are oxidized into ferric ions, whereby obtaining a slurry A; mixing the slurry A with a phosphoric acid solution and enabling reaction under a heating condition, whereby obtaining a slurry B; and subjecting the slurry B to solid-liquid separation treatment, washing treatment, drying treatment, and calcination treatment, whereby obtaining the regular octahedral iron phosphate.

### CROSS-REFERENCE TO RELATED APPLICATIONS

This application is the United States national phase of International Patent Application No. PCT/CN2023/111816 filed Aug. 8, 2023, and claims priority to Chinese Patent Application No. 202211070666.5 filed Sep. 2, 2022, the disclosures of each of which are hereby incorporated by reference in their entireties.

### BACKGROUND

### Technical Field

The present application relates to the technical field of electrode materials, and more particularly to a regular octahedral iron phosphate, a preparation method thereof, a lithium iron phosphate cathode material, and a lithium iron phosphate battery.

### Technical Considerations

Iron phosphate prepared by the existing technology mainly has spherical and flaky morphology, and only a few technologies mention the preparation of regular octahedral iron phosphate.

An existing preparation method proposes mixing graphene oxide and iron elements at a certain mass ratio, adding deionized water and absolute ethanol while stirring, adding H₂O₂ dropwisely while shaking, and then adding phosphate solution under an ultrasonic condition for ultrasonic reaction, controlling a ratio of Fe:P=1:2 to 2.5, then followed by dialysis and a hydrothermal reaction at 150° C. to 200° C., whereby obtaining a regular octahedral iron phosphate/graphene oxide material.

Another preparation method includes: adopting a phosphating slag, which is a by-product of a metal surface treatment, as a raw material, mixing the phosphating slag with oxalic acid and other substances for reaction to prepare iron hydroxyphosphate, and preparing iron phosphate. Such method requires strict control of the reaction temperature. Too high or too low the temperature cannot prepare the regular octahedral iron phosphate. For example, the iron phosphate prepared at 100° C. is in the shape of a short rod; the iron phosphate prepared at 150° C. is in the shape of a ball or short rod; and the iron phosphate prepared at 200° C. is in the shape of a regular octahedron, however, the edge and corner are unclear and the surface is severely broken. Only the iron phosphate prepared at 180° C. shows a complete regular octahedral morphology.

Existing preparation methods require constant temperature conditions or require strictly control of the temperature to produce the regular octahedral iron phosphate, and the reaction conditions are relatively harsh.

### SUMMARY

One of the purposes of the embodiments of the present application is to provide a regular octahedral iron phosphate, a preparation method thereof, a lithium iron phosphate cathode material, and a lithium iron phosphate battery, so as to solve the problems that the existing preparation methods in the existing technologies require constant temperature conditions or require strictly control of the temperature to produce the regular octahedral iron phosphate, and the reaction conditions are relatively harsh.

The technical solutions adopted by the present application are as follows:

In a first aspect, a method for preparing a regular octahedral iron phosphate is provided. The preparation method comprises:
obtaining a mixed solution A containing a phosphate and a ferrous salt, in which, the mixed solution A is an acidic solution;
mixing the mixed solution A with an oxidant, during which, ferrous ions in the mixed solution A are oxidized into ferric ions, whereby obtaining a slurry A;
mixing the slurry A with a phosphoric acid solution and enabling reaction under a heating condition, whereby obtaining a slurry B; and
subjecting the slurry B to solid-liquid separation treatment, washing treatment, drying treatment, and calcination treatment, whereby obtaining the regular octahedral iron phosphate.

In an embodiment, a pH of the mixed solution A is 1.8 to 2.5;
and/or, a molar ratio of an iron element to a phosphorus element in the mixed solution A is (5:3) to (5:5).

In an embodiment, a method for obtaining the mixed solution A comprises:
obtaining a phosphate solution; and
mixing the phosphate solution and the ferrous salt solution to obtain the mixed solution A.

In an embodiment, a concentration of the phosphorus element in the phosphate solution is 0.5 mol/L to 1.5 mol/L;
and/or, a pH of the phosphate solution is 4.5 to 6.5.

In an embodiment, a raw material for preparing the phosphate solution comprises at least one of ammonium monohydrogen phosphate, ammonium dihydrogen phosphate, ammonium phosphate, phosphoric acid, sodium monohydrogen phosphate, sodium dihydrogen phosphate, and/or sodium phosphate.

In an embodiment, a concentration of the iron element in the ferrous salt solution is 0.5 mol/L to 1.5 mol/L;

and/or, a raw material for preparing the ferrous salt solution comprises at least one of ferrous sulfate, ferrous nitrate, ferrous chloride, an iron powder, and/or an iron sheet.

In an embodiment, the oxidant comprises at least one of hydrogen peroxide, sodium persulfate, ammonium persulfate, ozone, and oxygen.

In an embodiment, a molar ratio of the iron element in the slurry A to phosphoric acid in the phosphoric acid solution is (5:1) to (5:3);
and/or, in the step of mixing the slurry A with a phosphoric acid solution and enabling reaction under a heating condition, a heating temperature is 80° C. to 100° C.

In a second aspect, a regular octahedral iron phosphate, being prepared by the method for preparing the regular octahedral iron phosphate as described in the above.

In a third aspect, a lithium iron phosphate cathode material, being made of the regular octahedral iron phosphate as described in the above.

In a fourth aspect, a lithium iron phosphate battery, comprising the lithium iron phosphate cathode material as described in the above.

The beneficial effects of the method for preparing the regular octahedral iron phosphate provided by the embodiments of the present application are summarized as follows: the acidic mixed solution A makes the ferrous ions insufficient to hydrolyze or react with phosphate to form ferric hydroxide or ferrous phosphate precipitation. An oxidant is added to the mixed solution A, and after the divalent ferrous ions are oxidized into trivalent ferric ions, a coprecipitate composed of iron phosphate and iron hydroxide is simultaneously formed in the system, thereby forming a precipitate of (FePO₄)₄Fe(OH)₃·nH₂O having a regular octahedral structure. Thereafter, the phosphoric acid solution is added to the slurry A, and under heating conditions, Fe (OH)₃ in the (FePO₄)₄Fe(OH)₃·nH₂O precursor material with the regular octahedron morphology is converted into FePO₄. During the conversion process, the overall structure of the precipitate has not changed and always maintains the regular octahedral structure.

The beneficial effects of the regular octahedral iron phosphate provided by the embodiments of the present application are summarized as follows: the tap density thereof is higher than the tap density of the iron phosphate having the conventional morphology, thus being suitable to be used as an ideal precursor for the cathode material of the lithium iron phosphate battery.

The beneficial effects of the lithium iron phosphate cathode material provided by the embodiments of the present application are summarized as follows: when the lithium iron phosphate cathode material prepared from the above regular octahedral iron phosphate as a precursor material is applied to the lithium iron phosphate batteries, the production costs of the lithium iron phosphate batteries can be reduced.

### BRIEF DESCRIPTION OF THE DRAWINGS

In order to more clearly illustrate the specific embodiments of the present application, the following will briefly introduce the accompanying drawings that need to be used in the description of the specific embodiments or exemplary technology. Obviously, the accompanying drawings in the following drawings are some implementations of the present application, and those skilled in the art can obtain other drawings based on these drawings without creative work.

FIG. 1 is a scanning electron microscope image showing a micromorphology of a regular octahedral iron phosphate prepared in Example 1 of the present application;

FIG. 2 is a scanning electron microscope image showing a micromorphology of a regular octahedral iron phosphate prepared in Example 2 of the present application;

FIG. 3 is a scanning electron microscope image showing a micromorphology of a regular octahedral iron phosphate prepared in Example 3 of the present application; and

FIG. 4 is a scanning electron microscope image showing a micromorphology of an iron phosphate prepared in Comparative Example 1 of the present application.

### DETAILED DESCRIPTION

In order to make the technical problems, technical solutions, and beneficial effects to be solved in the present application clearer, the present application will be further described in detail below in conjunction with the embodiments. It should be understood that the specific embodiments described here are only used to explain the present application, but are not intended to limit the present application.

It should be noted that when an element is described as “fixed” or “arranged” on/at another element, it means that the element can be directly or indirectly fixed or arranged on/at another element. When an element is described as “connected” to/with another element, it means that the element can be directly or indirectly connected to/with another element. It should be understood that terms “upper”, “lower”, “left”, “right” and the like indicating orientation or positional relationship are based on the orientation or the positional relationship shown in the drawings, and are merely for facilitating and simplifying the description of the present application, rather than indicating or implying that a device or component must have a particular orientation, or be configured or operated in a particular orientation, and thus should not be construed as limiting the application; and for those of ordinary skill in the art, the specific meanings of the above terms can be understood according to specific circumstances. The terms “first” and “second” are adopted for descriptive purposes only and are not to be construed as indicating or implying a relative importance or implicitly indicating the number of technical features indicated. The meaning of “a plurality of” or “multiple” is two or more unless otherwise specifically defined.

In order to illustrate the technical solutions provided by the present application, a detailed description will be given below with reference to specific drawings and embodiments.

Some embodiments of the present application provide a method for preparing a regular octahedral iron phosphate, which is performed by the following steps:

In step S10: a mixed solution A containing a phosphate and a ferrous salt is obtained, the mixed solution A is an acidic solution.

The acidic mixed solution A makes the ferrous ions insufficient to hydrolyze or react with phosphate to form ferric hydroxide or ferrous phosphate precipitation, maintaining the state of ferrous ions.

Optionally, a pH of the mixed solution A is 1.8 to 2.5. If the pH of the mixed solution A is higher than 2.5, the precipitation of ferrous hydroxide and ferrous phosphate may be resulted. If the pH of the mixed solution A is lower than 1.8, it may result that during the subsequent process of adding the oxidant for oxidizing ferrous ions into ferric ions, the hydrolysis reaction of ferrous ions is completely inhibited, and all ferric ions are precipitated in the form of iron phosphate, eventually forming flake-shaped iron phosphate. Therefore, the pH of the mixed solution A is selected to be 1.8 to 2.5, so that the ferrous ions in the solution can maintain their ionic state before being added with the oxidant, and also provide a reaction environment basis for the next step of the reaction.

Optionally, a method for obtaining the mixed solution A comprises:
obtaining a phosphate solution; and
mixing the phosphate solution and the ferrous salt solution to obtain the mixed solution A.

In this regard, the acidity of the mixed solution A can be regulated by at least three methods:

In a first method, after the phosphate solution and the ferrous salt solution are mixed, a pH regulator is added to regulate;

In a second method, the pH of the phosphate solution is regulated, so that after the phosphate solution and the ferrous salt solution are mixed, the pH of the mixed solution A reaches the preset value;

In a third method, the pH of the ferrous salt solution is regulated, so that after the phosphate solution and the ferrous salt solution are mixed, the pH of the mixed solution A reaches a preset value.

In an embodiment, the pH of the phosphate solution is 4.5 to 6.5, and the ferrous salt solution is an acidic solution. When the ferrous salt solution does not regulate the pH, the pH value of the phosphate solution is regulated to be in a range of 4.5 to 6.5, such that the pH value of mixed solution A formed by mixing the ferrous salt solution and phosphate solution is controlled to be in the range of 1.8 to 2.5.

The pH of the phosphate solution is regulated by a pH regulator, which includes at least one of ammonia water, ammonia gas, sodium hydroxide, sulfuric acid, and/or hydrochloric acid.

Optionally, a raw material for preparing the phosphate solution comprises at least one of ammonium monohydrogen phosphate, ammonium dihydrogen phosphate, ammonium phosphate, phosphoric acid, sodium monohydrogen phosphate, sodium dihydrogen phosphate, and/or sodium phosphate. Such raw material has strong solubility, the cations will not form precipitation with the anions in the ferrous salt solution, thus will not interfere with the precipitation reaction in the subsequent process.

When the pH of the phosphate solution needs to be regulated, for example, when the phosphate solution is prepared from phosphorus sources at a low pH such as ammonium dihydrogen phosphate and phosphoric acid, ammonia water, ammonia gas, sodium hydroxide and/or other substances can be used as the pH regulator to regulate the pH value of the phosphate salt raw material liquid to be 4.5 to 6.5; and when the phosphate solution is prepared from a phosphorus source at a high pH value, such as monoammonium phosphate and ammonium phosphate, sulfuric acid, hydrochloric acid and/or other substances can be used as the pH regulator to regulate the pH value of the phosphate salt raw material liquid to be 4.5 to 6.5.

It can be understood that the pH regulators of the ferrous salt solution and the mixed solution A may also include at least one of ammonia water, ammonia gas, sodium hydroxide, sulfuric acid, and/or hydrochloric acid.

Optionally, a concentration of the phosphorus element in the phosphate solution is 0.5 mol/L to 1.5 mol/L.

Optionally, a concentration of the iron element in the ferrous salt solution is 0.5 mol/L to 1.5 mol/L.

Optionally, the raw material for preparing the ferrous salt solution includes at least one of ferrous sulfate, ferrous nitrate, ferrous chloride, an iron powder, and/or an iron sheet. These raw materials can all be prepared into a soluble ferrous salt, in which, the anions in ferrous sulfate, ferrous nitrate, and ferrous chloride will not form precipitates with the ammonium ions and the sodium ions.

Optionally, a molar ratio of an iron element to a phosphorus element in the mixed solution A is (5:3) to (5:5), which provides an element ratio for oxidation and coprecipitation. By controlling the molar ratio of the iron element to the phosphorus element to be (5:3) to (5:5), it is ensured that after adding the oxidant in step S20, the main component of the precipitate is (FePO₄)₄Fe(OH)₃·nH₂O having a regular octahedral structure.

In step S20: the mixed solution A is mixed with an oxidant, during which, ferrous ions in the mixed solution A are oxidized into ferric ions, whereby obtaining a slurry A.

An oxidant is added to the mixed solution A, and after the divalent ferrous ions are oxidized into trivalent ferric ions, a coprecipitate composed of iron phosphate and iron hydroxide is simultaneously formed in the system, thereby forming a precipitate of (FePO₄)₄Fe(OH)₃·nH₂O having a regular octahedral structure.

It can be understood that the mixed solution A and the oxidant are mixed under a stirring condition, so that the mixed solution A and the oxidant are fully mixed.

Optionally, the oxidant includes at least one of hydrogen peroxide, sodium persulfate, ammonium persulfate, ozone, and/or oxygen.

The amount of oxidant added is sufficient to oxidize all the ferrous irons in mixed solution A into ferric irons. A slight excessive dose of the oxidant can be used to ensure that the ferrous iron is completely oxidized.

In step S30: the slurry A is mixed with a phosphoric acid solution and reaction is enabled under a heating condition, whereby obtaining a slurry B.

The phosphoric acid solution is added to the slurry A, and under heating conditions, Fe(OH)₃ in the (FePO₄)₄Fe(OH)₃·nH₂O precursor material with the regular octahedron morphology is converted into FePO₄. During the conversion process, the overall structure of the precipitate has not changed and always maintains the regular octahedral structure.

Optionally, a molar ratio of the iron element in slurry A to phosphoric acid in the phosphoric acid solution is (5:1) to (5:3).

Optionally, in the step of mixing the slurry A with a phosphoric acid solution and enabling reaction under a heating condition, a heating temperature is 80° C. to 100° C.

It can be understood that the slurry A and the phosphoric acid solution are mixed under the stirring condition, so that the slurry A and the phosphoric acid solution are fully mixed and evenly contact with each other.

The reaction principles of steps S20 and S30 are as follows:

In step S20, after the mixed solution A and the oxidant are mixed,

Fe³⁺+H₂O→Fe(OH)²⁺+H⁺, \textcircled{1}

Fe(OH)²⁺+H₂O→Fe(OH)²⁺+H⁺, \textcircled{2}

Fe³⁺+2H₂PO₄⁻→Fe(H₂PO₄)²⁺, \textcircled{3}

Fe(H₂PO₄)²⁺+3H₂O+Fe(OH)²⁺→2FePO₄·2H₂O+2H⁺, \textcircled{4}

Fe(OH)²⁺+H₂O→Fe(OH)₃+2H⁺, \textcircled{5}

It can be known from (\textcircled{1}+\textcircled{2}+\textcircled{3}+\textcircled{4})*2 that

4Fe³⁺+4H₂PO⁴⁻+10H₂O→4FePO₄·2H₂O+8H⁺,

It can be known from (\textcircled{1}+\textcircled{2}+\textcircled{3}) that

Fe³⁺+3H₂O→Fe(OH)₃+3H⁺,

Total equation: (\textcircled{1}+\textcircled{2}+\textcircled{3}+\textcircled{4})*2+(\textcircled{1}+\textcircled{2}+\textcircled{3})

That is, 5Fe³⁺+4H₂PO₄⁻+(8n−4)H₂O→[Fe(PO₄)]₄Fe(OH)₃·nH₂O+11H⁺.

In step S30, after the addition of phosphoric acid, the temperature is raised for carrying out the following convention:

[Fe(PO₄)]₄Fe(OH)₃·nH₂O+H₃PO₄→5FePO₄·2H₂O+mH₂O.

In step S40: the slurry B is subjected to solid-liquid separation treatment, washing treatment, drying treatment, and calcination treatment, whereby obtaining the regular octahedral iron phosphate.

The procedures and the equipment involved in the solid-liquid separation treatment, washing treatment, and drying treatment can be the common procedures or equipment in the existing iron phosphate preparation technology.

In the method for preparing the regular octahedral iron phosphate provided in the embodiments of the present application, the ratio of iron element to phosphorus element in the mixed solution A is controlled to be (5:3) to (5:5), and in combination with the pH value control of the mixed solution A, the molecular formula and morphological structure of the precipitate (FePO₄)₄Fe(OH)₃·nH₂O generated by the reaction can be accurately controlled. The precipitate (FePO₄)₄Fe(OH)₃·nH₂O is an octahedral precursor material, and then the temperature is increased by adding phosphoric acid solution to convert the Fe(OH)₃ component in the regular octahedral precursor material into FePO₄.

Compared with the existing technology, the method for preparing the regular octahedral iron phosphate provided by the embodiments of the present application does not require constant temperature conditions nor require controlling the temperature at a specific temperature, and avoids the harsh reaction conditions of high temperature, high pressure, and long cycles of the hydrothermal method/solvent method. Moreover, the method of present application greatly reduces the amount of phosphorus source, significantly reduces the production cost of regular octahedral iron phosphate, and prepares regular octahedral iron phosphate through a coprecipitation method through relatively mild reaction conditions.

The embodiments of the present application also provide a regular octahedral iron phosphate made by using the above preparation method of the regular octahedral iron phosphate. The tap density of the regular octahedral iron phosphate provided in the embodiments of the present application can reach 0.8 g/cm³ to 1.2g/cm³, which has a tap density higher than that of iron phosphate with a conventional morphology, can be used as an ideal precursor for a lithium iron phosphate cathode material, and has better filtration and washing performance, that is, the regular octahedral iron phosphate in the embodiments of the present application shows high filtration speed, better washing effect, and more water-saving during the washing, for example, during the same washing methods and equipment, the washing water consumption of regular octahedral iron phosphate is about 30 m³/t, while the washing water consumption of conventional iron phosphate is about 40 m³/t to 70 m³/t.

Regular octahedral iron phosphate provided in the embodiments of the present application can be used as a precursor material to prepare a lithium iron phosphate cathode material. The prepared lithium iron phosphate cathode material can be used in a lithium iron phosphate battery, which can reduce the production cost of the lithium iron phosphate battery.

Hereinbelow, multiple examples are adopted to further illustrate the present application.

### EXAMPLE 1

A regular octahedral iron phosphate was prepared by performing the following steps:
in step S01: 460 g of ammonium dihydrogen phosphate was collected and dissolved, added with ammonia water to regulate a pH of a resulting solution to 5.0, and 4 L of a phosphate solution was obtained;
in step S02: 1390 g of ferrous sulfate heptahydrate was collected and dissolved, and a resulting volume thereof was regulated to 4 L, to obtain a ferrous salt solution;
in step S03: a phosphate solution and the ferrous salt solution were mixed under a stirring condition to obtain a mixed solution A, in which, a pH of the mixed solution A was 2.3;
in step S04: under continuous stirring conditions, 300 g of a 30 wt. % hydrogen peroxide solution was slowly dropped into the mixed solution A, and reacted for 30 mins to obtain a slurry A;
in step S05: 230 g of a 85 wt. % phosphoric acid solution was added to the slurry A, and the temperature was raised to 90° C. and maintained at such temperature for 2 hrs, so as to obtain a white slurry B; and
in step S06: the slurry B was then filtered, washed, and dried to obtain a regular octahedral iron phosphate. A tap density of the regular octahedral iron phosphate was 0.85 g/cm³, and the micromorphology of the regular octahedral iron phosphate prepared in this example is shown in FIG. 1.

### EXAMPLE 2

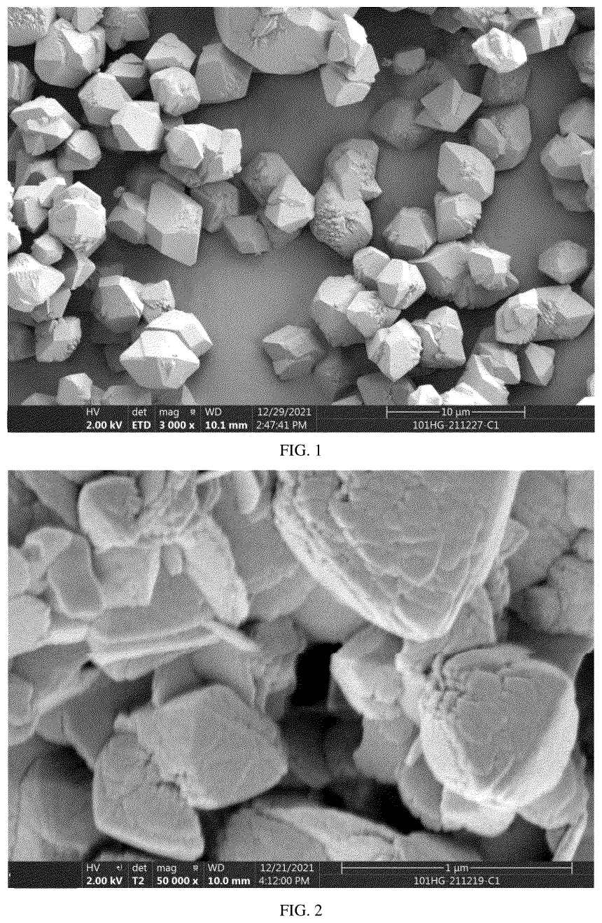

A regular octahedral iron phosphate was prepared by performing the following steps:
in step S01: 460 g of a 85 wt. % phosphoric acid solution was collected, added with sodium hydroxide to regulate a pH value of a resulting solution to 4.8, and 4 L of a phosphate solution was obtained;
in step S02: 810 g of ferrous chloride tetrahydrate were collected and dissolved, and a resulting volume thereof was regulated to 4 L, to obtain a ferrous salt solution;
in step S03: a phosphate solution and the ferrous salt solution were mixed under a stirring condition to obtain a mixed solution A, in which, a pH of the mixed solution A was 2.2;
in step S04: under continuous stirring conditions, 460 g of a 20 wt. % hydrogen peroxide solution was slowly dropped into the mixed solution A, and reacted for 30 mins to obtain a slurry A;
in step S05: 200 g of a 85 wt. % phosphoric acid solution was added to the slurry A, then the temperature was raised to 85° C. and maintained at such temperature for 2 hrs, so as to obtain a white slurry B; and
in step S06: the slurry B was then filtered, washed, and dried to obtain a regular octahedral iron phosphate. A tap density of the regular octahedral iron phosphate was 0.93 g/cm³, and the micromorphology of the regular octahedral iron phosphate prepared in this example is shown in FIG. 2.

### EXAMPLE 3

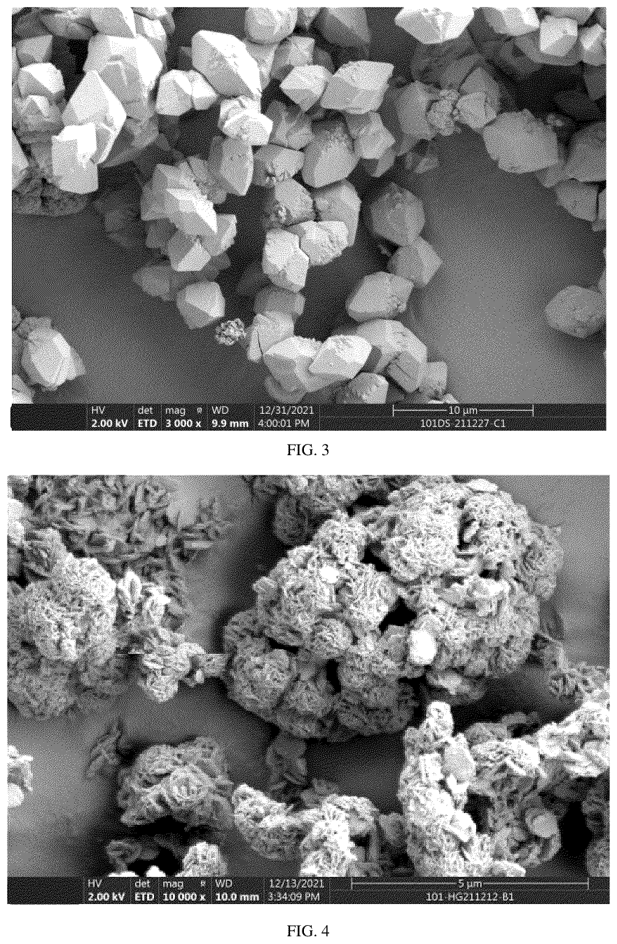

A regular octahedral iron phosphate was prepared by performing the following steps:
in step S01: 528 g of ammonium monohydrogen phosphate was collected and dissolved, and added with sulfuric acid to regulate a pH to 6.5, and 4 L of a phosphate solution was obtained;
in step S02: 1390 g of ferrous sulfate heptahydrate was collected and dissolved, and a resulting volume thereof was regulated to 4 L, to obtain a ferrous salt solution;
in step S03: a phosphate solution and the ferrous salt solution were mixed and stirred evenly to obtain a mixed solution A, in which, a pH of the mixed solution A was 2.5;
in step S04: under continuous stirring, 300 g of a 30 wt. % hydrogen peroxide solution was slowly dropped into the mixed solution A, and then reacted for 30 mins to obtain a slurry A;
in step S05: 300 g of a 80 wt. % phosphoric acid solution was added to the slurry A, then the temperature was raised to 92° C. and maintained at such temperature for 2 hrs, so as to obtain a white slurry B; and
in step S06: the slurry B was filtered, washed, and dried, to obtain a regular octahedral iron phosphate. A tap density of the regular octahedral iron phosphate was 1.11 g/cm³, and the micromorphology of the regular octahedral iron phosphate prepared in this example is shown in FIG. 3.

### EXAMPLE 4

A regular octahedral iron phosphate was prepared by performing the following steps:
in step S01: 460 g of ammonium dihydrogen phosphate was collected and dissolved in water, and added with an ammonia water to regulate the pH value of a resulting solution to 5.5, and 4 L of a phosphate solution was obtained;
in step S02: 1390 g of ferrous sulfate heptahydrate was collected and dissolved in water, and a resulting volume thereof was regulated to 4 L, to obtain a ferrous salt solution;
in step S03: a phosphate solution and the ferrous salt solution were mixed and stirred evenly to obtain a mixed solution A, in which, a pH of the mixed solution A was 2.4;
in step S04: under continuous stirring conditions, a solution contained 600 g of dissolved ammonium persulfate was slowly added the mixed solution A, and then reacted for 30 mins to obtain a slurry A;
in step S05: 340 g of a 85 wt. % phosphoric acid solution was added to the slurry A, then the temperature was raised to 90° C. and maintained at such temperature for 2 hrs, so as to obtain a white slurry B; and
in step S06: the slurry B was filtered, washed, and dried, to obtain a regular octahedral iron phosphate. A tap density of the regular octahedral iron phosphate was 1.07 g/cm³,

### Comparative Example 1

The preparation method of iron phosphate in this comparative example is a preparation method of conventional morphological iron phosphate. The steps of comparative example 1 are similar to those of Example 1. The proportions of reaction raw materials are the same. A molar ratio in the mixed solution formed by mixing the ferrous salt solution and the phosphate solution is 5:4. The added phosphoric acid satisfies the condition that the molar ratio of iron element to phosphoric acid is 5:2.

This comparative example is different from Example 1 in that the pH value of the phosphate solution is not regulated.

An iron phosphate in this comparative example was prepared by performing the following steps:
in step S01: 460 g of ammonium dihydrogen phosphate was collected and dissolved to obtain 4 L of a phosphate solution, in which, the pH value of the phosphate solution was 3.92;
in step S02: 1390 g of ferrous sulfate heptahydrate was collected and dissolved, and a resulting volume thereof was regulated to 4 L, to obtain a ferrous salt solution;
in step S03: a phosphate solution and the ferrous salt solution was mixed and stirred evenly to obtain a mixed solution A, in which, a pH of the mixed solution A was 1.5;
in step S04: under continuous stirring, 300 g of a 30 wt. % hydrogen peroxide solution was slowly dropped into the mixed solution A, and then reacted for 30 mins to obtain a slurry A.
in step S05: 230 g of a 85 wt. % phosphoric acid solution was added to the slurry A, the temperature was raised to 90° C. and maintained at such temperature for 2 hrs, so as to obtain a white slurry B; and
in step S06: the slurry B was then filtered, washed, and dried to obtain an iron phosphate, and the micromorphology of the iron phosphate is shown in FIG. 4.

### Comparative Example 2

This comparative example is a preparation method of conventional morphological iron phosphate. The steps of this comparative example are similar to those of Example 1, except the following differences: a molar ratio of the iron element and the phosphorus element in the mixed solution formed by mixing the ferrous salt solution and the phosphate solution is 5:4.

An iron phosphate of this comparative example was prepared by performing the following steps:
in step S01: 534 g of ammonium dihydrogen phosphate was collected and dissolved, added with ammonia water to regulate a pH of a resulting solution to 5.0, and 4 L of a phosphate solution was obtained;
in step S02: 1112 g of ferrous sulfate heptahydrate was collected and dissolved, and a resulting volume thereof was regulated to 4 L, to obtain a ferrous salt solution;
in step S03: a phosphate solution and the ferrous salt solution were mixed and evenly stirred to obtain a mixed solution A, in which, a pH of the mixed solution A was 2.1;
in step S04: under continuous stirring conditions, 300 g of a 30 wt. % hydrogen peroxide solution was slowly dropped into the mixed solution A, and then reacted for 30 mins to obtain a slurry A;
in step S05: 184 g of a 85 wt. % phosphoric acid solution was added to the slurry A, and the temperature was raised to 90° C. and maintained at such temperature for 2 hrs, so as to obtain a white slurry B; and
in step S06: the slurry B was then filtered, washed, and dried to obtain an iron phosphate, and the micromorphology of the iron phosphate is a conventional and non-octahedral morphology.

It can be seen that all of Examples 1 to 4 can prepare regular octahedral iron phosphate, and the iron phosphates prepared in Comparative Example 1 and Comparative Example 2 are all iron phosphates having the conventional morphology.

The iron phosphate obtained in Comparative Example 1 showed a regular morphology, which may be because that the pH value of the phosphate solution was not regulated, and the pH of the ferrous salt solution was not regulated either, in which, the pH of mixed solution A was lower than 1.8, and the pH value of the reaction system relatively low. At a low reaction pH value, the hydrolysis of ferric ions is inhibited. Most of the precipitates generated in the slurry A are FePO₄·nH₂O. The morphology of the precursor material affects the morphology of the final product of iron phosphate. Without the production of the regular octahedral precursor material (FePO₄)₄Fe(OH)₃·nH₂O, the final iron phosphate cannot have the regular octahedral morphology.

The iron phosphate obtained in Comparative Example 2 is similar to Comparative Example 1 and does not have a regular octahedral morphology. The reason may be that the molar ratio of the iron element to the phosphorus element in mixed solution A is not controlled within the range of 5:3 to 5:5, and the regular octahedral precursor material (FePO₄)₄Fe(OH)₃·nH₂O cannot be formed. When the iron element is too little, the iron ions preferentially combine with phosphate to form an iron phosphate precipitate, and the amount of Fe(OH)₃ formed is small, making it difficult to form a regular octahedral structure; and when the iron element is too much, the hydrolysis of iron ions will produce too much Fe(OH)₃ colloid, which causes the precursor material to exhibit a rice-like amorphous morphology, making it impossible to obtain iron phosphate having a regular octahedral morphology.

The above are only optional embodiments of the application, and are not intended to limit the application. For those skilled in the art, various modifications and changes may be made to the present application. Any modifications, equivalent replacements, improvements, etc. made within the spirit and principles of the present application shall be included within the scope of the claims of the present application.

1. A method for preparing a regular octahedral iron phosphate, comprising:
obtaining a mixed solution A comprising a phosphate and a ferrous salt, wherein the mixed solution A is an acidic solution;
mixing the mixed solution A with an oxidant, during which, ferrous ions in the mixed solution A are oxidized into ferric ions, whereby obtaining a slurry A;
mixing the slurry A with a phosphoric acid solution and enabling reaction under a heating condition, whereby obtaining a slurry B; and
subjecting the slurry B to solid-liquid separation treatment, washing treatment, drying treatment, and calcination treatment, whereby obtaining the regular octahedral iron phosphate.

2. The method for preparing the regular octahedral iron phosphate according to claim 1, wherein a pH of the mixed solution A is 1.8 to 2.5.

3. The method for preparing the regular octahedral iron phosphate according to claim 1, wherein a molar ratio of an iron element to a phosphorus element in the mixed solution A is (5:3) to (5:5).

4. The method for preparing the regular octahedral iron phosphate according claim 1, wherein a method for obtaining the mixed solution A comprises:
obtaining a phosphate solution; and
mixing the phosphate solution and the ferrous salt solution to obtain the mixed solution A.

5. The method for preparing the regular octahedral iron phosphate according to claim 4, wherein a concentration of a phosphorus element in the phosphate solution is (0.5 to 1.5) mol/L.

6. The method for preparing the regular octahedral iron phosphate according to claim 4, wherein a pH of the phosphate solution is 4.5 to 6.5.

7. The method for preparing the regular octahedral iron phosphate according to claim 4, wherein a raw material for preparing the phosphate solution comprises at least one of ammonium monohydrogen phosphate, ammonium dihydrogen phosphate, ammonium phosphate, phosphoric acid, sodium monohydrogen phosphate, sodium dihydrogen phosphate, and/or sodium phosphate.

8. The method for preparing the regular octahedral iron phosphate according to claim 4, wherein a concentration of an iron element in the ferrous salt solution is (0.5 to 1.5) mol/L.

9. The method for preparing the regular octahedral iron phosphate according to claim 4, wherein a raw material for preparing the ferrous salt solution comprises at least one of ferrous sulfate, ferrous nitrate, ferrous chloride, an iron powder, and/or an iron sheet.

10. The method for preparing the regular octahedral iron phosphate according to claim 1, wherein the oxidant comprises at least one of hydrogen peroxide, sodium persulfate, ammonium persulfate, ozone, and/or oxygen.

11. The method for preparing the regular octahedral iron phosphate according to claim 1, wherein a molar ratio of an iron element in the slurry A to phosphoric acid in the phosphoric acid solution is (5:1) to (5:3).

12. The method for preparing the regular octahedral iron phosphate according to claim 1, wherein in the step of mixing the slurry A with a phosphoric acid solution and enabling reaction under a heating condition, a heating temperature is 80° C. to 100° C.

13. A regular octahedral iron phosphate, being prepared by the method for preparing the regular octahedral iron phosphate according to claim 1.

14. The regular octahedral iron phosphate according to claim 13, wherein a tap density of the regular octahedral iron phosphate is 0.8 g/cm³ to 1.2g/cm³.

15. (canceled)

16. A lithium iron phosphate battery, comprising lithium iron phosphate cathode material comprising the regular octahedral iron phosphate according to claim 13.

17. The method for preparing the regular octahedral iron phosphate according to claim 2, wherein a molar ratio of an iron element to a phosphorus element in the mixed solution A is (5:3) to (5:5).

18. The method for preparing the regular octahedral iron phosphate according to claim 3, wherein a method for obtaining the mixed solution A comprises:
obtaining a phosphate solution; and
mixing the phosphate solution and the ferrous salt solution to obtain the mixed solution A.

19. The method for preparing the regular octahedral iron phosphate according to claim 5, wherein a pH of the phosphate solution is 4.5 to 6.5.

20. The method for preparing the regular octahedral iron phosphate according to claim 6, wherein a raw material for preparing the phosphate solution comprises at least one of ammonium monohydrogen phosphate, ammonium dihydrogen phosphate, ammonium phosphate, phosphoric acid, sodium monohydrogen phosphate, sodium dihydrogen phosphate, and/or sodium phosphate.

21. The method for preparing the regular octahedral iron phosphate according to claim 7, wherein a concentration of an iron element in the ferrous salt solution is (0.5 to 1.5) mol/L.
